(19) United States
(12) Patent Application Publication
(10) Pub. No.: US 2009/0305217 A1
(43) Pub. Date: Dec. 10, 2009

(54) COMPUTERIZED EDUCATIONAL RESOURCE PRESENTATION AND TRACKING SYSTEM

(75) Inventors: Kathleen P. Mulcahy, Seattle, WA (US); John Solaro, Bellevue, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/136,763

(22) Filed: Jun. 10, 2008

(51) Int. Cl. G09B 7/00

(52) U.S. Cl. 434/362

(57) ABSTRACT

A computerized educational resource presentation and tracking system is provided. The system includes a collection of stored educational resources organized according to user accounts for each of a plurality of users, a presentation application configured to present at least some of the collection of stored educational resources at a client device of each of the plurality of users. The presentation application may include an educational resource module configured to create a modified version of a specified educational resource in response to receiving a user-generated edit of the specified educational resource, the modified version having metadata to link to a previous version of the specified educational resource. The presentation application may further include a presentation generator configured to generate a presentation of a user-selected subset of the collection of educational resources including the modified version of the specified educational resource, ordered in a user-specified presentation order.

### BACKGROUND

In an educational environment, teachers take educational materials, splice them up, edit them, and put them back together in various ways to create content that is appropriate for their lessons and their students. When educational materials created by a plurality of different teachers are shared in a collection, the collection may include many similar or redundant materials. For example, the collection may include many copies of similar content with slight differences such as the order, grade-level appropriateness, language, and other things. This is indicative of duplicated efforts on the part of teachers. Further, in a collection with many redundant materials, it may be difficult to find relevant content, consuming valuable lesson planning time.

### SUMMARY

A computerized educational resource presentation and tracking system is provided. The system comprises a collection of stored educational resources accessible via a networked server, each educational resource having metadata utilized to organize the collection of stored educational resources. The collection of stored educational resources is further organized according to user accounts for each of a plurality of users and shared across the accounts according to user-specifiable permissions. The system may further include a presentation application configured to present at least some of the collection of stored educational resources from the networked server at a client device of each of the plurality of users. The presentation application may include an educational resource module configured to create a modified version of a specified educational resource of the collection of stored educational resources in response to receiving a user-generated edit of the specified educational resource, the modified version having metadata to link to a previous version of the specified educational resource. The presentation application may further include a presentation generator configured to generate a presentation of a user-selected subset of the collection of educational resources including the modified version of the specified educational resource, which is ordered in a user-specified presentation order.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a schematic view illustrating a computerized resource presentation and tracking system according to an embodiment of the present disclosure.

FIG. 2 is a schematic view illustrating an embodiment of an educational resource.

FIG. 3 is a schematic view illustrating a modified version of the educational resource of FIG. 2.

FIG. 4 is a schematic view illustrating an embodiment of a presentation of ordered educational resources.

FIG. 5 is a schematic view illustrating another presentation of educational resources created as a result of modifying the presentation of FIG. 4.

FIG. 6 is a schematic view illustrating an embodiment of a search graphical user interface of a presentation application of the computerized resource presentation and tracking system of FIG. 1.

FIG. 7 is a flowchart of an embodiment of a method of generating a presentation of educational resources and tracking edits to the educational resources.

### DETAILED DESCRIPTION

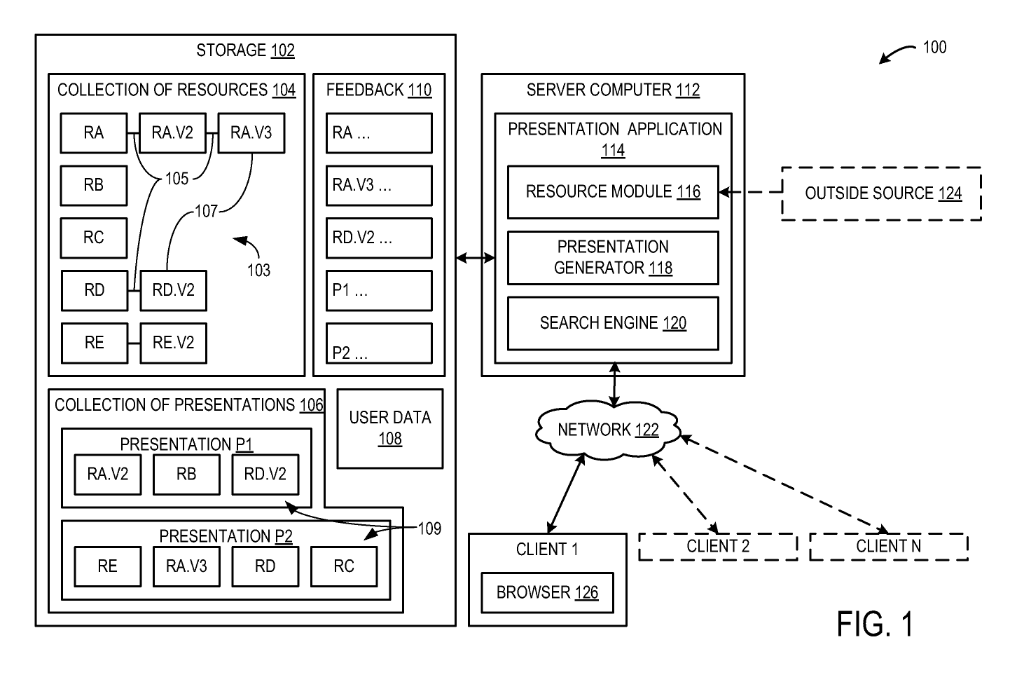

The present disclosure is directed to creating and editing educational resources for use in presentations that may be presented to an audience in an educational setting. FIG. 1 shows a schematic view illustrating an embodiment of a computerized resource presentation and tracking system 100 in accordance with the present disclosure. Computerized resource presentation and tracking system 100 includes a collection of resources 104 stored in a storage device 102 accessible via a networked server computer 112. In one example, the storage device is a mass storage device, such as a hard drive, and the data stored thereon is organized in a database. As described in detail below, resources 103 in the collection of resources 104 may be used and modified by users of the system 100, and the versions of resources 103 may be tracked by the system to aid users in efficiently locating appropriate resources for educational presentations.

The collection of resources 104 may include a plurality of component resources 103, illustrated schematically as resource A (RA)—resource E (RE) in FIG. 1. The resources 103 may be of virtually any suitable file type that may be utilized to present content to a user. In the examples discussed herein, the resources are discussed in the context of presenting educational material and thus may be referred to as educational resources. In a particular example, educational resources 103 may include image files, audio files, video files, electronic presentation slide deck files, document files, and the like. In some cases a resource may have interactive content such as a form, executable file, or script. Such interactive content may be used to implement a quiz, survey, or other educational assessment mechanism, for example.

To facilitate customization of the educational resources 103, system 100 may be configured to store a plurality of different versions 107 of a resource in the collection of resources 104, which versions 107 have been created and stored by users of the system 100. Further, to enable users to navigate and search the resources 103, each educational resource 103 of the collection of educational resources 104 may include metadata utilized to organize the educational resources 103 according to a predefined schema that is searchable by a search engine 120, as discussed below.

When plural different versions of an educational resource are included in the collection of educational resources, each version of an educational resource may include metadata link 105 that links the version to a previous version of that educational resource. For example, a version of a particular educational resource may include a metadata link 105 to a most previous version of that educational resource. In such an example, all versions of a particular educational resource may be linked to one another via parent-child links that form chain or branching tree structure, and the chain or branching tree structure may be traversed by following a link 105 from one version to the next version. In another example, a version of a particular educational resource may include metadata links 105 to all other versions of that educational resource. In such an example, all versions may be accessed directly from every other version via a particular link. As yet another alternative, each version of a resource may be linked in hub-and-spoke fashion to an original version of the resource, which in turn contains links to all versions of the resource. In the illustrated example, educational resource A is linked to educational resource A-version 2, which in turn is linked to educational resource A-version 3, by a link 105 in a chain linking fashion. Further, while some resources 103 may include multiple versions 107, it will be appreciated that only a single version of other resources may exist in the collection of resources 104.

As described in detail below, the various resources 103 in the collection of resources 104 may be included in presentations 109 by users. The system 100 may be configured to store these presentations 109 in a collection of presentations 106 in storage device 102. Each presentation 109 or collection of presentations 106 may include an ordered subset of educational resources 103 from the collection of educational resources 104. A presentation 109 may be a file that may be interpreted by a client device, such as a browser 126, for presentation to an audience. In some embodiments, the presentation 106 may be organized to include a deck of slides in a presentation order, and resources 103 may be included within the slides in the deck, or may include one or more of the slides themselves.

In the illustrated example, presentation P1 has an ordered subset of educational resources that includes educational resource A-version 2, educational resource B, and educational resource D-version 2 presentable in that order, while presentation P2 has an ordered subset of educational resources that includes educational resource B, educational resource A-version 3, educational resource D, and educational resource C, in that order.

The collection of educational resources 104 may be organized according to user accounts for each of a plurality of users of resource presentation and tracking system 100. The educational resources 103 may be shared across accounts according to user-specifiable permissions. In this manner, users may create online communities and groups for sharing educational resources, as desired. User data 108, stored in storage device 102, may include user account information as well as the permissions of each user, to implement such functionality.

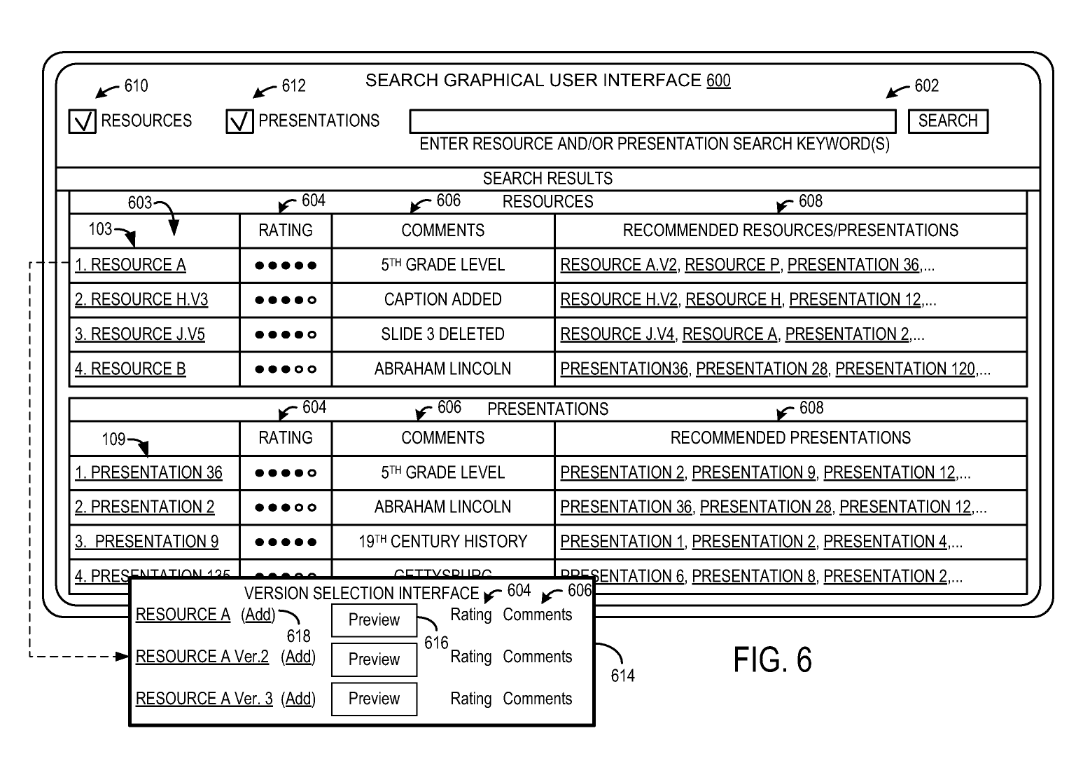

Throughout use of the educational resources, a user may form opinions on the usefulness of a particular resource 103, and wish to inform other users of these opinions. To accomplish this, the system 100 is configured to receive user generated feedback 110 relating to particular educational resources 103. Feedback 110 may be stored in storage device 102 in a manner that is linked to the subject educational resources 103, and may include ratings of each educational resource as well as recommendations for educational resources and/or presentations that relate to a specified educational resource, for example. These ratings and recommendations may be displayed in search results of search engine 120, as described below and illustrated in FIG. 6.

Continuing with FIG. 1, a presentation application 114 may be provided and at least partially executable on server computer 112. Presentation application 114 may be in communication with a plurality of client devices via network 122, such as client 1, client 2, and client N each of which are operable by different users on respective client computing devices. Presentation application 114 may be configured to present at least some of the collection of educational resources 104 and at least some of the collection of presentations 106 at a client device of each of the plurality of users. In one example, the presentation application 114 may be accessible by a web browser 126 of a client device, such as client device 1. Presentation application 114 may be configured to present educational resources and/or presentations in a pane of web browser 126, for example. Alternatively, a thin client or other executable program on the client device may be provided for displaying the interface of presentation application 114.

Presentation application 114 may include an educational resource module 116, a presentation generator 118, and a search engine 120, as described below. In response to user commands, educational resource module 116 may be configured to create a new educational resource, upload an existing educational resource, and/or edit a stored educational resource to create a modified version 107 of that educational resource. Educational resource module 116 may further include a creation tool for creating new educational resources. For example, the creation tool may enable a user to input text, images, video, and/or audio. In addition, the creation tool may enable a user to design a layout or appearance of an educational resource. For example, the creation tool may enable the user to format the size, color, and style of text, insert images, video and audio, and create hyperlinks, forms, and other interactive content, all of which affect the appearance of an educational resource.

Educational resource module 116 may be configured to receive a user upload of one or more existing educational resources to collection of stored educational resources 104. In one example, educational resource module 116 may receive an educational resource from an outside source 124, such as a third-party website. Upon uploading an educational resource, the resource module 116 may be configured to add user-generated metadata to the educational resource so that the educational resource may be suitably organized in the collection of educational resources 104. In some embodiments, the educational resource module 116 may be configured to convert an educational resource received from an outside source to a suitable format to be uploaded to the collection of educational resources. For example, images, video, or audio may be converted to a standard format for storage.

Educational resource module 116 may be configured to edit an educational resource from the collection of educational resources 104. In particular, educational resource module 116 may be configured to create a modified version 107 of a specified educational resource of the collection of stored educational resources in response to receiving a user-generated edit of the specified educational resource. Upon creation of the modified version 107, a link 105 to a previous version of the resource and comments describing how the modified version differs from the specified educational resource may be added to the metadata. Educational resource module 116 may be configured to add the modified version to collection of stored educational resources 104 for future use in presentations. In this manner, it will be appreciated that educational resource module 116 may be configured to enable the creation of multiple versions of each educational resource in the collection of stored educational resources by one or more users of the system.

A particular use case scenario illustrating a user editing an educational resource using resource module 116 follows. A fifth grade teacher may select an educational resource in the form of a slide deck about Abraham Lincoln for a presentation on the Civil War from the collection of educational resources. However, upon viewing the slide deck in the presentation application, the fifth grade teacher realizes that the content of the slide deck was created for a third grade audience. Thus, the fifth grade teacher decides to make the slide deck content more challenging for the fifth grade class. Subsequently, the fifth grade teacher edits the slide deck using the presentation application and the resource module creates a new version of the slide deck with the fifth grade teacher's edits. During editing, the fifth grade teacher adds the comments “Made material more challenging to include more details of Abraham Lincoln's life and more advanced vocabulary”. Accordingly, the comments and a link to the previous version of the slide deck are added to the metadata of the modified version of the slide deck. The modified version of the slide deck is stored in the collection of educational resources for future use.

Turning to the presentation generator 118, the presentation generator 118 may be configured to generate a presentation 109 of a user-selected subset of collection of educational resources 104 ordered in a user-specified presentation order. In other words, a user may select a desired number of educational resources from the collection of educational resources and further may determine the order of presentation of the educational resources. In response to such user input, the presentation generator may create a presentation file including the educational resources ordered as specified by the user. It will be appreciated that the newly created presentation may be stored in the collection of presentations for future use.

Furthermore, presentation generator 118 may be configured to generate a new presentation based on existing presentations 109 of collection of presentations 106. In particular, a user may view an existing presentation from the collection of presentations 106 and may edit the existing presentation by adding, subtracting or changing the order of educational resources 103. Furthermore, the user may edit one or more of the educational resources 103 in the existing presentation. Presentation generator 118 may create a new presentation based on the user edits and may store the new presentation in collection of presentations 106. FIGS. 4 and 5, discussed below, include schematic examples a new presentation P4 created by a user based on an existing presentation P3. In some embodiments, the existing presentation and new presentation may each include metadata, such as versioning links between the new and previous versions of the presentations, and editing comments.

Continuing with FIG. 1, a particular use case scenario illustrating a user editing a presentation using presentation generator 118 follows. A teacher views a presentation 106 from the collection of presentations 106 in the presentation application 114. The presentation is about the Civil War and includes the following educational resources presented in the following order, an introduction video, a slide deck, an image of Abraham Lincoln, and an interactive quiz. The teacher decides to edit the presentation order to be ordered as follows, introduction video, image of Abraham Lincoln, slide deck, and interactive quiz. The presentation generator creates a new presentation based on the change to the presentation order and stores the new presentation in the collection of presentations.

Search engine 120 may be configured to search the metadata of each educational resource and/or presentation of the collection of stored educational resources and/or the collection of presentations according to search keyword(s) and present the search results via a search graphical user interface (GUI), as illustrated in FIG. 6 and described below. In particular, the search results may include at least one of the educational resources and/or the presentations ordered by relevance based upon the search criteria.

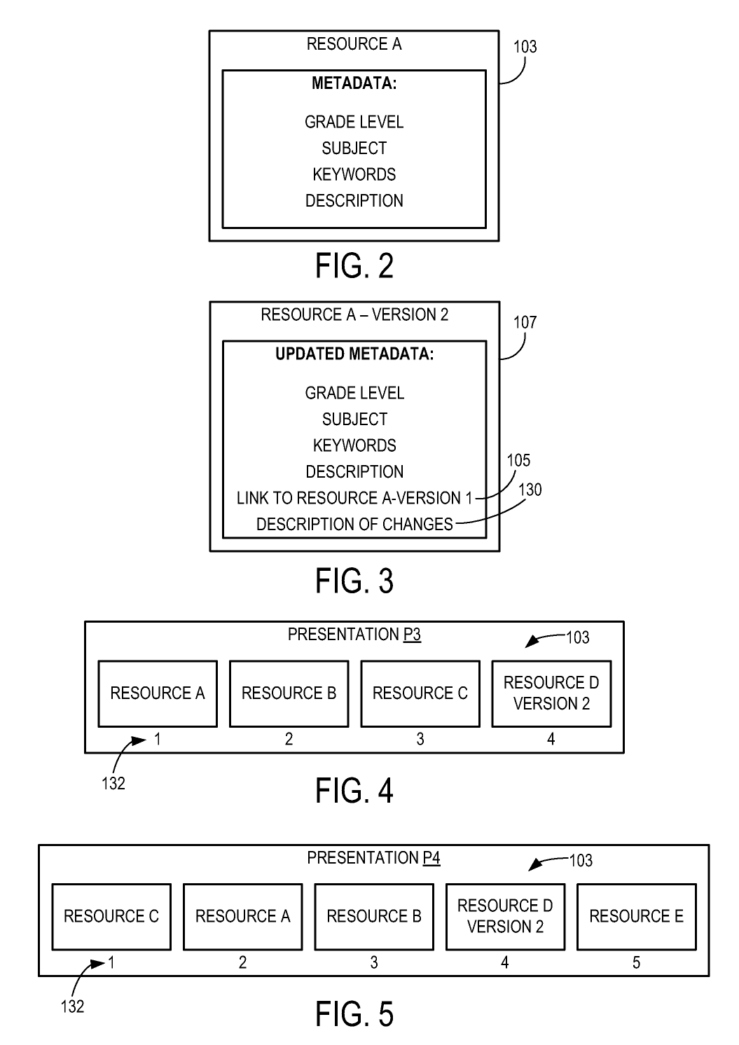

FIG. 2 is a schematic view of an embodiment of an educational resource A which includes metadata of the educational resource. Educational resource A includes metadata organized into grade level, subject, keywords, and a description. It will be appreciated that these categories are merely examples, and other metadata may be provided as desired. The grade level metadata may describe the learning level of the intended audience of the educational resource. Further, the grade level metadata may provide an indication of the complexity of the content of an educational resource. The subject metadata may describe a particular pedagogical skill, such as math, science, social studies, history, etc. The keyword metadata may include particular terms that may be analyzed by the search engine 120 when performing a search of the collection of educational resources. The description metadata may include a brief textual description of the content of the educational resource, such as “an image of Abraham Lincoln”, “text of the Gettysburg Address”, “Civil War quiz”, etc. At least some of the above described metadata may be presented with each educational resource to provide supplemental information to a user in order to aid the user in discerning between different educational resources and version for a presentation. The metadata of the educational resource may also include hyperlinks to learning objectives, standards, or other educational resources, as desired.

FIG. 3 is a schematic view of an embodiment of a modified version 107 of the educational resource 103 of FIG. 2, which includes the metadata of the modified version 107. Educational resource A-version 2 includes the same metadata as educational resource A, and in addition, includes a metadata link 105 to resource A and change description metadata 130. The metadata link 105 may enable a user to easily move from one version of educational resource A to the other version of educational resource A when searching for a desired educational resource. The change description metadata 130 may include user textual comments describing how the modified version differs from the educational resource. Example of such textual comments in the change description metadata 130 may include: “3^{rd} grade vocabulary complexity”, “removed topic,” “changed color scheme,” etc. The change description metadata 130 may enable a user to more easily discern differences between different versions of an educational resource.

It will be appreciated that although the metadata of educational resource A is retained in educational resource A-version 2, in some examples the metadata may change, for example, by new metadata being added. For example, if additional content is added to a modified version of a resource, then additional keywords may be added to the keyword metadata of the modified version of the educational resource.

FIG. 4 is a schematic view of an embodiment of a presentation P3 of an ordered subset of educational resources 103. Presentation P3 is an example of a presentation that may be created by a user at a client device utilizing the presentation application 114. Presentation P3 includes four educational resources 103 presentable in a presentation order 132 as follows: educational resource A, educational resource B, educational resource C, and educational resource D-version 2. It will be appreciated that the educational resources in presentation P3 are a subset of the resources 103 in the collection of educational resources 104 of FIG. 1, and that the presentation order 132 of the subset of educational resources 103 is generated by the user.

FIG. 5 is a schematic view of an embodiment of a presentation P4 created as a result of modifying presentation 1 of FIG. 4. Presentation P4 includes five educational resources 103 presentable in a presentation order 132 as follows: educational resource C, educational resource A, educational resource B, educational resource D-version 2, and educational resource E. It will be observed that the presentation order and the number of educational resources in the presentation P4 have been modified from presentation P2. Educational resource C has been moved to the beginning of the presentation order and educational resource E has been added to the end of the presentation order.

As a use case scenario illustrating the modifications made in FIGS. 4 and 5, a teacher may search for an existing presentation on a topic and find presentation P3. The teacher may find aspects of presentation P3 suitable, but may desire to make some additional changes to the presentation to customize the presentation to the teacher's lesson plan. Thus, the teacher moves educational resource C (e.g. an image) to the beginning of the presentation order to change the emphasis of the introduction, for example. Further, the teacher adds educational resource E (e.g. an interactive quiz) to the end of the presentation order to test the students on the material presented in the presentation. By modifying an existing presentation, the teacher can build upon the effort and group knowledge of other teachers in the online community, while still customizing the presentation to meet the objectives of the teacher's lesson plan.

FIG. 6 is a schematic view of a search GUI 600 of the search engine 120 of the presentation application 114. The search GUI 600 may include a search query field 602 configured to receive a user input search query. Upon receiving the search query the search engine is configured to search the collection of educational resources and presentations and retrieve search results 603 for display on search GUI 600. Search results 603 may include one or more educational resources and/or presentations from the collection of educational resources 104 and/or the collection of presentations 106. Search engine 120 may include a search algorithm that retrieves the educational resources 103 and/or presentations 109 in the search results based on metadata that is tagged to the educational resources 103 and/or presentations 109, among other relevant factors. For example, a keyword may be entered into search field 602 and the search engine 120 may be configured to search the metadata for the keyword and retrieve the educational resources and/or presentations having matching or relevant metadata. Specific examples of types of metadata that may be defined and searched via keywords in the search query include a pedagogical skill or subject, grade level, rating, and keywords defined for each educational resource, as illustrated in FIGS. 2 and 3.

The search results 603 may be presented in a ranked order according to relevance of a keyword search. Each retrieved educational resource and presentation in the search results 603 may be presented with ratings 604, comments 606, and recommendations 608, and other relevant metadata of the resources and presentations. Ratings 604 may be user submitted and may provide an indication of the quality of a particular educational resource or presentation, and are stored as part of feedback 110 illustrated in FIG. 1 and described above. Comments 606 may be metadata of a particular educational resource or presentation that describes the content of the educational resource 103 or presentation 109, and are typically input by an author of the resource in as description metadata described in relation to FIGS. 2 and 3. In the case of a versioned educational resource, comments 606 may also include textual descriptions from the change description metadata 130 illustrated in FIG. 3, if such metadata is available, describing how one version differs from another version of an educational resource.

Recommendations 608 may include a list of other educational resources and/or presentations that are related to a particular educational resource or presentation. Typically, the recommendations are ranked based according to a recommendation algorithm. The recommendation algorithm may be configured formulate recommendations 608 to include one or more versions of a particular educational resource. In one example, each educational resource of the search results is presented with one or more alternative versions, and in some embodiments all versions, of that resource on the graphical user interface, as recommendations 608. In another example, recommendations 608 may include one or more presentations 109 that include the particular educational resource 103. Thus, each educational resource 103 of the search results 603 may be presented with one or more alternative presentations, and in some embodiments all presentations, containing that educational resource, as recommendations 608. In this manner the search engine 120 may be used by a user to find educational resources and/or presentations relating to a desired topic in order to create a presentation for use in an educational setting.

It will be appreciated that as an alternative to, or in addition to, the depicted ratings 604, comments 606, and recommendations 608, the search results 603 may include other metadata related to each resource 103 and/or presentation 109. For example, the search results may include thumbnail images, usage statistics, format information, award data, author information, etc.

In the example illustrated in FIG. 6, a keyword search has produced a list of search results 603 with the educational resource A ranked as the most relevant educational resource 103. A rating 604 indicates that educational resource A has been rated five out of five by users. Comments 606 about educational resource A identify educational resource A as having a fifth grade learning level. Recommendations 608 include a list of related educational resources and presentations that are recommended for educational resource A, including educational resource A-version 2, educational resource P, and presentation 36. It will be appreciated that the metadata itself may be editable by an author of the resource, or by a group or all members of the online community, according to settings selected by the author.

Search GUI 600 may include educational resource selector 610 and presentation selector 612 for selectively presenting educational resources and/or presentations based on the keyword searching. Educational resource selector 610 and presentation selector 612 are illustrated as checkboxes, and configured to receive user input to control selective presentation of the educational resources and/or the presentations. Thus, if selector 610 is checked, resources will be displayed in the search results 603, and if presentation selector 612 is checked, presentations will be displayed in the search results 603. While these selectors are illustrated as checkboxes in the depicted embodiment it will be appreciated that other forms of input tools may alternatively be utilized.

Search GUI 600 may also be configured to receive a user selection of a desired resource or presentation from the search results 603, and to present the window with a version selection interface 614. It will be appreciated that the search results 603 may be hyperlinked and the user selection may be a click on a hyperlink of the search results. The version selection interface 614 may in turn be configured to present the user with a list of all versions of the resource or presentation. A preview 616, such as a thumbnail image, may be provided along with ratings 604 and comments 606 to enable the user to select from among the different versions. While the version selection interface is depicted as a pop-up window, it will be appreciated that in other embodiments, the version selection interface may be implemented as part of the search results 603 list, or in another suitable manner within search GUI 600. For example, the content of the version selection interface 614 may be displayed as recommendations 608 in some embodiments.

An example use case scenario for search GUI 600 follows. A teacher may desire to add an educational resource to a presentation about Abraham Lincoln. The teacher performs a search for the keywords “Gettysburg Address” as well as metadata for “subject: History and Gettysburg Address and Grade Level: 4-8”. In response to this search query, the search engine 120 retrieves a subset of educational resources, ranked by relevance by the ranking algorithm. Once the teacher selects a desired educational resource from the ranked results, the teacher is presented with the version selection interface, including a version list populated with various versions of the educational resource. The teacher may select an appropriate version of the educational resource. By clicking an add selector 618, the search engine 120 is configured to cause the presentation generator 118 to add the selected resource to the current presentation. The teacher may use the selected educational resource as-is or make edits to create a new version of the educational resource, as described above.

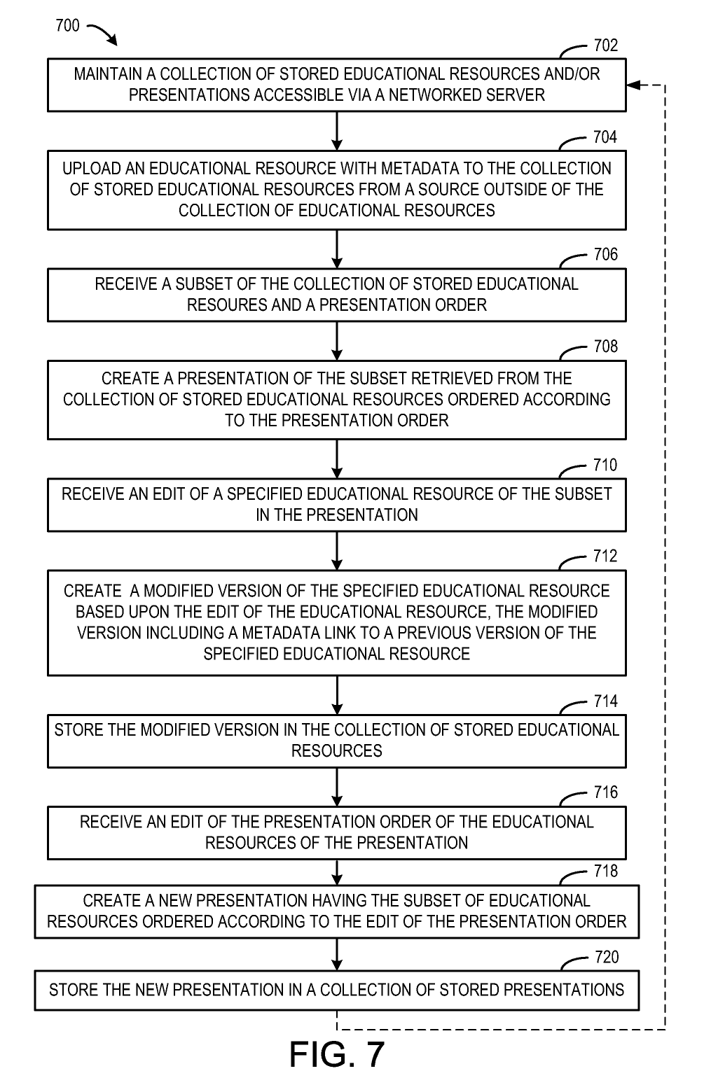

FIG. 7 shows a flowchart of an example method 700 of creating a presentation of educational resources ordered according to a user-specified presentation order. Method 700 may include, at 702, maintaining a collection of stored educational resources and/or presentations accessible via a networked server, each of the educational resources including metadata utilized to organize the collection of educational resources. The educational resources may further be organized according to user accounts and may be shared among different user accounts based on user-specifiable permissions, or by educational institution (e.g., school, district, college, interest group, etc.).

At 704, the method may include uploading an educational resource with metadata to the collection of stored educational resources from a source outside of the collection of educational resources. For example, the educational resource may be uploaded from a third-party website by a resource module of a presentation application executed on a networked server. By uploading educational resources to the collection of educational resources in this manner, the collection may grow quickly to contain many educational resources useful in creating presentations.

At 706, the method may include receiving user input indicative of a subset of the collection of stored educational resources and a presentation order. This user input may be received via a presentation generator of the presentation application executed on the networked server, as described above. At 708, the method may include creating a presentation of the subset retrieved from the collection of stored educational resources ordered according to the presentation order. It will be appreciated that the presentation may be created by the presentation generator.

At 710, the method may include receiving an edit of a specified educational resource of the subset in the presentation. An edit may include adding, removing, and/or changing content or appearance of an educational resource, for example. At 712, the method may include creating a modified version of the specified educational resource based upon the edit, the modified version including a metadata link to a previous version of the specified educational resource. In some embodiments, the modified version may include metadata links to one or more alternative versions of the specified educational resource. Further, in some embodiments, the metadata of the modified version may include comments describing how the modified version differs from the specified educational resource. It will be appreciated that metadata may be received as user input or programmatically generated. For example, a user may input a grade level, or a grade level for an educational resource may be programmatically generated (inferred) by analyzing usage patterns of the author, related resources, or other factors. At 714, the method may include storing the modified version in the collection of stored educational resources. By storing the modified version in the collection, the modified version may be available for future use in presentations by the user as well as other users. It will be appreciated that receiving the edit, creating the modified version of the resource, and storing the modified version of the resource as described above may be accomplished by a resource module of the presentation application executed by the networked server, as described above.

At 716, the method may include receiving an edit of the presentation order of the educational resources of the presentation. It will be appreciated that any reordering of educational resources in the presentation, or any addition, deletion or modification of an educational resource in a presentation will result in an edit to the presentation order of the presentation. With regard to modification of a resource in the presentation, the presentation order will change to include the modified version instead of the original version. At 718, the method may include creating a new presentation having the subset of educational resource ordered according to the edit of the presentation order. At 720, the method may further include storing the new presentation in a collection of stored presentations on the networked server. It will be appreciated that receiving an edit of the presentation, and creating and storing the presentation may be accomplished by the presentation generator module of the presentation application executed on the server.

The method may subsequently loop to maintaining the collection of educational resources at 702. In this manner, the modified version of the resource and the new presentation that have been stored by users at 714 and 720 may be made available to other users of the networked server, subject to user assignable access permissions. As a result, the collection of resource may grow and become more useful to users.

The above systems and methods may encourage effective use of educational resources and presentations generated by an online community of users. By maintaining a collection of educational resources having a variety of versions that are linked to other versions, the collection may be more easily searchable to find educational resources that are relevant to the objectives of the educator's lesson plan. Moreover, since relevant educational resources are more easily searchable, educators may conserve precious lesson planning time, while at the same time avoid duplicating the efforts of others by creating redundant copies of educational resources. In this way, the collection of educational resources may be made more useful and effective for creating presentations since the collection is not diluted with redundant copies, which can potentially frustrate search efforts.

It will be appreciated that the embodiments described herein may be implemented, for example, via computer-executable instructions or code, such as programs, stored on computer-readable storage media and executed by a computing device, such as a processor of server computing subsystem, for example. Generally, programs include routines, objects, components, data structures, and the like that perform particular tasks or implement particular abstract data types. As used herein, the term “program” may connote a single program or multiple programs acting in concert, and may be used to denote applications, services, or any other type or class of program. Likewise, the terms “computer” and “computing device” as used herein include any device that electronically executes one or more programs, including, but not limited to, personal computers, servers, laptop computers, hand-held devices, microprocessor-based programmable consumer electronics and/or appliances, etc.

It will be understood that the embodiments herein are illustrative and not restrictive, since the scope of the invention is defined by the appended claims rather than by the description preceding them, and all changes that fall within metes and bounds of the claims, or equivalence of such metes and bounds thereof are therefore intended to be embraced by the claims.

1. A computerized educational resource presentation and tracking system comprising:
a collection of stored educational resources accessible via a networked server, each educational resource having metadata utilized to organize the collection of stored educational resources, the collection of stored educational resources further being organized according to user accounts for each of a plurality of users and shared across the accounts according to user-specifiable permissions; and
a presentation application configured to present at least some of the collection of stored educational resources from the networked server at a client device of each of the plurality of users, and including an educational resource module configured to create a modified version of a specified educational resource of the collection of stored educational resources in response to receiving a user-generated edit of the specified educational resource, the modified version having metadata to link to a previous version of the specified educational resource, the presentation application further including a presentation generator configured to generate a presentation of a user-selected subset of the collection of educational resources including the modified version of the specified educational resource, ordered in a user-specified presentation order.

2. The system of claim 1, wherein the educational resource module is further configured to receive a user upload of one or more existing educational resources to the collection of stored educational resources.

3. The system of claim 1, wherein the educational resource module is further configured to add the modified version to the collection of stored educational resources.

4. The system of claim 1, wherein the educational resource module is further configured to enable the creation of multiple versions of each educational resource in the collection of stored educational resources by one or more users of the system.

5. The system of claim 4, wherein metadata of each version of the multiple versions includes a link to a most previous version of that educational resource.

6. The system of claim 4, wherein metadata of each version of the multiple versions includes links to all other versions of that educational resource.

7. The system of claim 1, wherein the presentation application is further configured to present plural versions of a specified educational resource for viewing and selection based upon availability of plural versions in the collection of stored educational resources.

8. The system of claim 1, wherein metadata of the modified version includes a description of how the modified version differs from the specified educational resource.

9. The system of claim 1, wherein each educational resource is selected from a group consisting of image files, video files, slide deck files, executable files, and document files.

10. The system of claim 1, wherein metadata of each educational resource includes grade level, subject, keywords, and a description of the resource.

11. The system of claim 1, wherein the collection further includes presentations of ordered subsets of the collection of stored educational resources.

12. A method for presenting educational resources to each of a plurality of users over a distributed network and tracking changes to the educational resources made by each of the plurality of users, the method comprising:
maintaining a collection of stored educational resources accessible via a networked server, each of the resources including metadata utilized to organize the collection of educational resources;
receiving a subset of the collection of stored educational resources and a presentation order;
creating a presentation of the subset retrieved from the collection of stored educational resources ordered according to the presentation order;
receiving an edit of a specified educational resource of the subset in the presentation; and
creating a modified version of the specified educational resource based upon the edit, the modified version including a metadata link to a previous version of the specified educational resource.

13. The method of claim 12, further comprising:
storing the modified version in the collection of stored educational resources.

14. The method of claim 12, further comprising:
receiving an edit of the presentation order of the presentation;
creating a new presentation having the subset of educational resources ordered according to the edit of the presentation order; and
storing the new presentation in a collection of stored presentations.

15. The method of claim 12, further comprising:
uploading an educational resource with metadata to the collection of stored educational resources from a source outside of the collection of educational resources.

16. The method of claim 12, wherein metadata of the modified version of the educational resource includes comments describing how the modified version differs from the specified educational resource.

17. The method of claim 12, wherein metadata of the modified version includes a link to all versions of the specified educational resource.

18. A computerized educational resource presentation and tracking system comprising:
a presentation application, at least partially executable on a networked server, configured to serve at least some of a collection of stored educational resources and presentations retrieved from the networked server to a client device of each of a plurality of users, the presentation application including:
a search engine operable via a graphical user interface presentable on the client device of each of the plurality of users, configured to search the collection of stored educational resources and presentations by keyword and further configured to selectively present, on the graphical user interface, search results including at least one of educational resources and/or presentations ordered by relevance based upon the keyword;
a resource module configured to create a modified version of a specified educational resource of the search results based upon a user-generated edit of the specified educational resource, the modified version having a metadata link to a previous version of the specified educational resource; and
a presentation generator configured to generate a presentation of a user-selected subset of educational resource of the collection of resources, the presentation including the modified version of the specified educational resource, the presentation being ordered according to a user-specified presentation order.

19. The system of claim 18, wherein each educational resource of the search results is presented with one or more alternative versions of that resource on the graphical user interface.

20. The system of claim 18, wherein each educational resource of the search results is presented with one or more alternative presentations containing that educational resource.
